(19) United States
(12) Patent Application Publication
(10) Pub. No.: US 2014/0305714 A1
(43) Pub. Date: Oct. 16, 2014

(54) APPARATUS FOR POWERING A MOVABLE CARRIER

(71) Applicant: Ming-Chang Huang, Taoyuan County (TW)

(72) Inventor: Ming-Chang Huang, Taoyuan County (TW)

(21) Appl. No.: 13/863,406

(22) Filed: Apr. 16, 2013

(51) Int. Cl. B60L 9/00; F01D 15/02

(52) U.S. Cl. CPC B60L 9/00; F01D 15/02
USPC 180/2.1

(57) ABSTRACT

One object of this invention is to provide an apparatus for powering a movable carrier in a flexible and cost-effective way. Present invention discloses an apparatus for powering a movable carrier, comprising: an adaptor on the movable carrier for connecting to a energy source carried by a portable holder, wherein the portable holder comprises a connector to couple the energy source to the adaptor; an energy converter attached to the movable carrier and connected to the adaptor, for converting the energy source to kinetic-energy for moving the movable carrier.

### BACKGROUND OF THE INVENTION

I. Field of the Invention

The present invention relates to a bicycle and more particularly to a powered bicycle.

II. Description of the Prior Art

A person usually rides on a bicycle for moving; however, it takes lots of energy of the person to move the bicycle. Conventional powered bicycle has a fixed structure to power the bicycle, for example, a motor and a battery are attached, in a fixed manner, to the bicycle for moving. In addition, the battery cannot be easily upgraded for larger capacity due to the limitation of the fixed arrangement of the motor and the battery on the bicycle.

Therefore, what is needed is a flexible way to power a bicycle while taking advantage of the battery as much as possible.

### SUMMARY OF THE INVENTION

One object of this invention is to provide an apparatus for powering a movable carrier in a flexible and cost-effective way.

Present invention discloses an apparatus for powering a movable carrier, comprising: an adaptor on the movable carrier for connecting to a energy source carried by a wearable holder, wherein the wearable holder comprises a connector to couple the energy source to the adaptor; an energy converter attached to the movable carrier and connected to the adaptor, for converting the energy source to kinetic-energy for moving the movable carrier.

In one embodiment, the movable carrier is a bicycle, wherein the energy source is a battery and the energy converter is a motor, wherein the motor is attached to a wheel or a pedal of the bicycle.

In one embodiment, the movable carrier is a segway, wherein the energy source is a battery and the energy converter is a motor, wherein the motor is attached to a wheel of the segway.

In one embodiment, the movable carrier is a energy saving car, wherein the energy source is a pressure air/gas and the energy converter is a air turbine/decompressor, wherein the turbine/decompressor is attached to a wheel of the energy saving car.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a block diagram of a powered movable carrier according to current invention;

FIG. 2A-2E illustrates a block diagram of a powered bicycle utilizing a motor or an turbine for moving the bicycle in accordance with one embodiment of current invention;

FIG. 3 illustrates a block diagram of a powered bicycle utilizing a power generator for charging the embedded battery of bicycle;

FIG. 4 illustrates a block diagram of a powered segway in accordance with one embodiment of current invention;

FIG. 5 illustrates a block diagram of a powered bicycle utilizing a motor and an air turbine for moving the bicycle in accordance with another embodiment of current invention;

FIG. 6A-6G illustrates examples of a plug of a adaptor on the powered bicycle in accordance with one embodiment of current invention;

FIG. 7A-7E illustrates examples of a wearable bag in accordance with one embodiment of current invention.

### DETAILED DESCRIPTION OF THE INVENTION

The detailed explanation of the present invention is described as following. The described preferred embodiments are presented for purposes of illustrations and description, and they are not intended to limit the scope of the present invention.

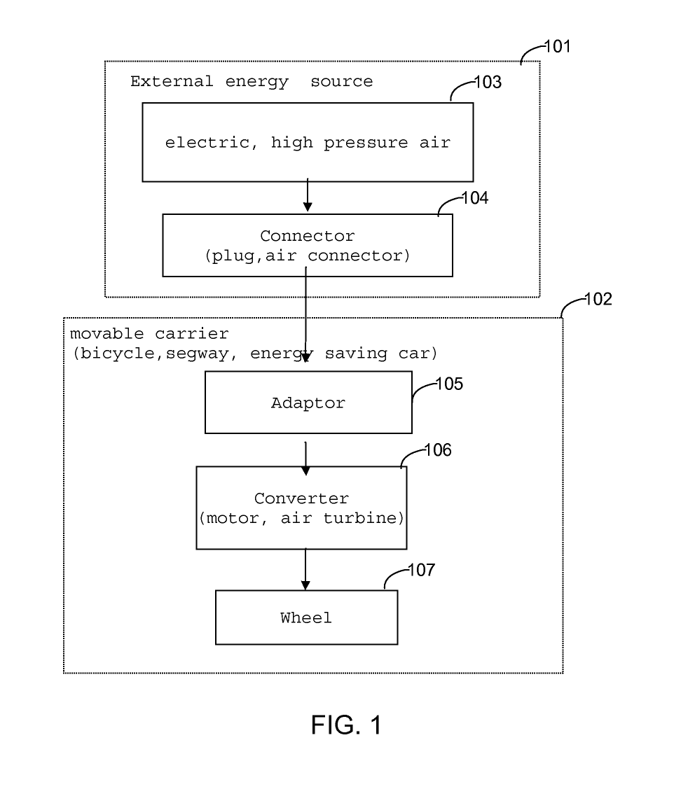

FIG. 1 illustrates an apparatus for powering a movable carrier 102, wherein the apparatus comprises: an adaptor 105 on the movable carrier 102 for connecting to a energy source 103 carried by a wearable holder 101, wherein the wearable holder 101 comprises a connector 104 to couple the energy source 103 to the adaptor 105; an energy converter 106 attached to the movable carrier 102 and connected to the adaptor 105, for converting the energy source 103 to kinetic-energy for moving the movable carrier 102. The energy converter 106 can be attached to a wheel 107 or a pedal of the movable carrier 102. The energy source can be a battery and the energy convertor can be a motor; the energy source can be pressured air/gas and the energy convertor can be a turbine engine; the energy source can be fuel and the energy convertor can be an engine. The wearable holder 101 can be, for example, a bag, a belt, or other holders to hold the energy source103, which will be described in details later. The adaptor 105 is attached to a fixed portion of the movable carrier to connect the energy source 103 to the energy converter 106. The wearable holder such as a wearable bag has a connector 104 to connect the adaptor 105 attached to a fixed portion of the movable carrier 102, so that the person riding on the movable carrier 102 will not be impacted when the movable carrier is moving by the energy source 103 and the energy converter 106.

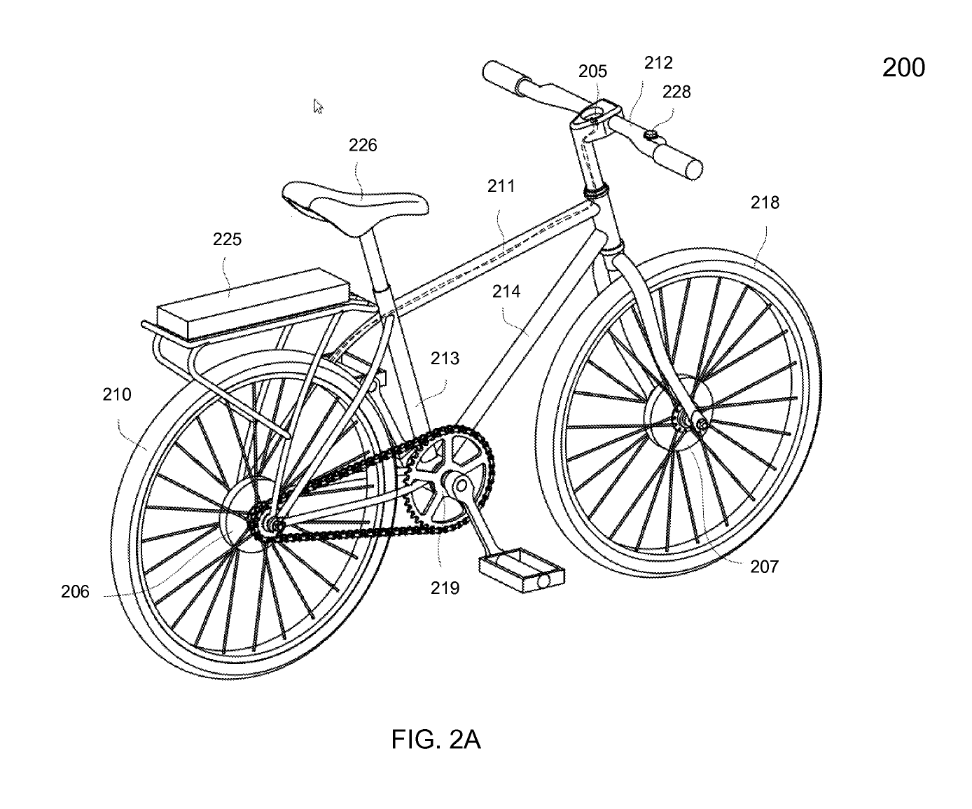

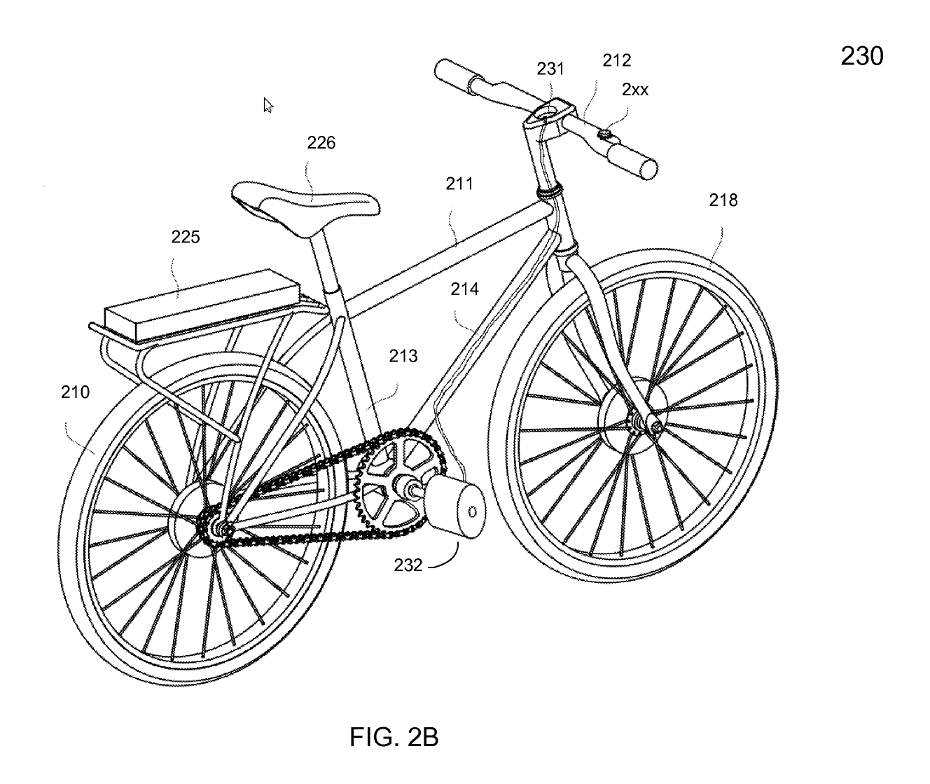

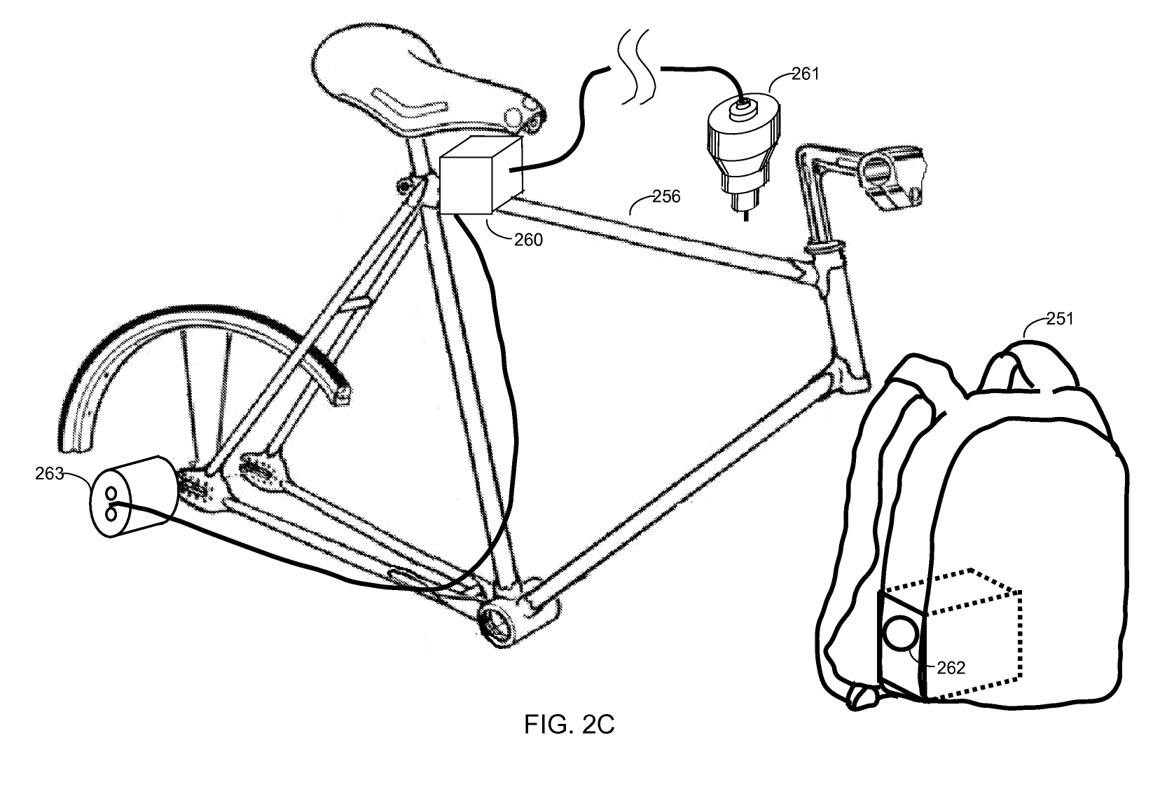

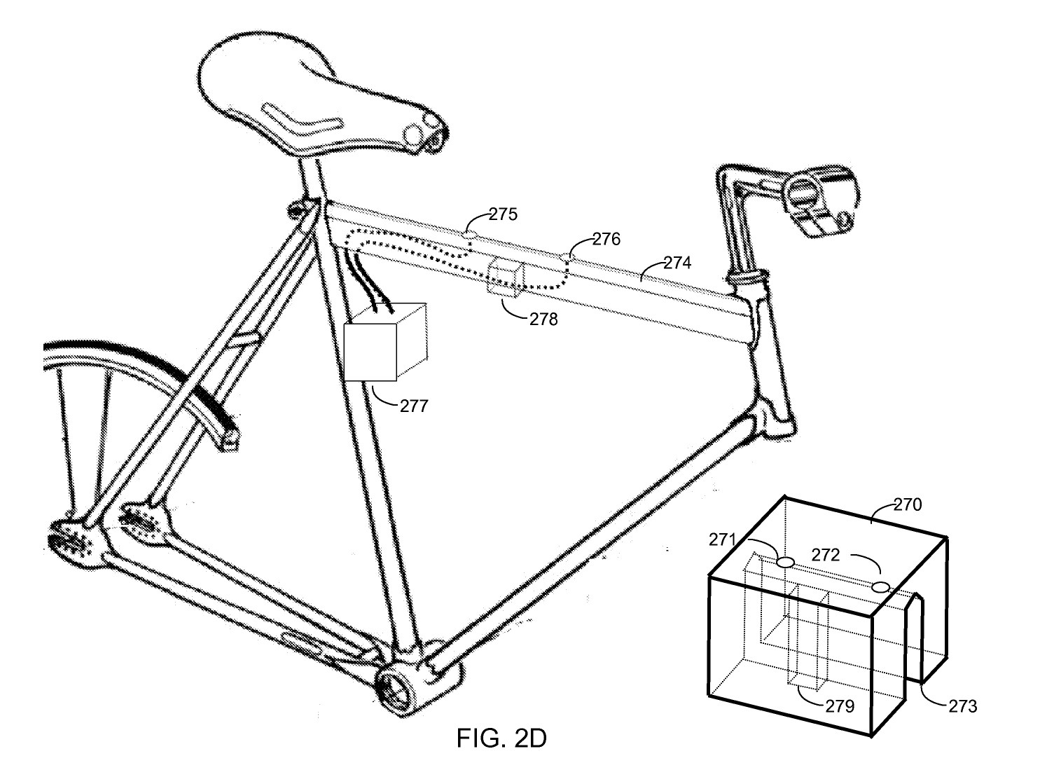

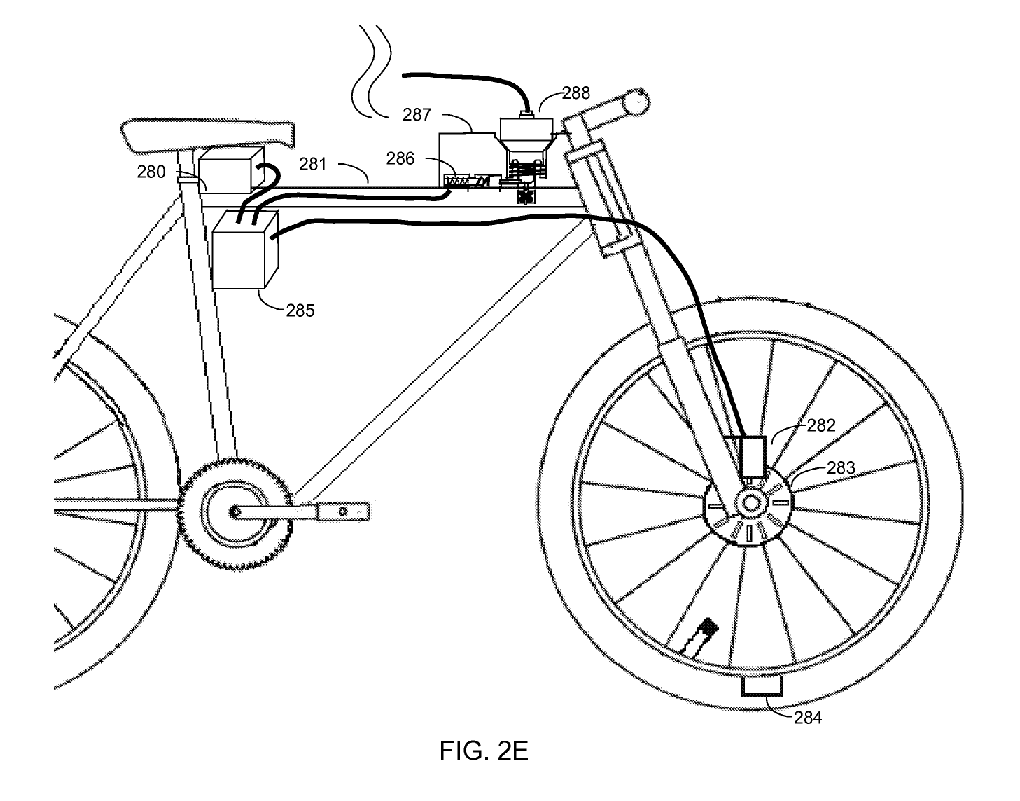

FIG. 2A illustrates a block diagram of a powered bicycle utilizing a motor for moving the bicycle in accordance with one embodiment of current invention. As shown in FIG. 2A, the apparatus for powering the bicycle comprises: an adaptor 205 on the bicycle 200 for connecting to an external battery, wherein the external battery can be carried in a portable holder to hold the battery. The portable holder can be a wearable bag, or a belt, which is carried by a driver riding on the bicycle. The portable holder can be attached the bicycle while riding on the bicycle. The portable holder comprises a connector to couple the external battery to the adaptor 205. A motor 206 is attached to a pedal 219, rotating axis 206 of the rear wheel 210 or rotating axis 207 of the front wheel 218, of the bicycle and is connected to the adaptor 205, for converting the electricity to kinetic-energy for moving the bicycle. The adaptor 205 is attached to a fixed portion of the bicycle to connect the battery to the motor 206. The fixed portion of the bicycle can be the horizontal frame 211, slops 213, 214, handle 212, back seat 225, a location under the driver seat 226, and so on. The adaptor 205 is located at, for example, the handle 212 as shown in FIG. 2A. In one embodiment, there is a switch 228 that can turn on or off the power from the external battery to the motor 206. The motor 206 can be an electrical hub motor that can be attached to the rotating axis 206 of the rear wheel 210 or rotating axis 207 of the front wheel 218, of the bicycle. The adaptor is connected to the motor by a plurality of wires which are located inside a supporting frame such as horizontal frame 211 as shown in FIG. 2A. In one embodiment, the adaptor comprises a plug for connecting the connector of the holder. The plug can be in many types, for example, an electro-magnetic type.

FIG. 2B illustrates a block diagram of a powered bicycle utilizing air pressure for moving the bicycle in accordance with one embodiment of current invention. As shown in FIG. 2B, the apparatus for powering the bicycle 230 comprises: an adaptor 231 on the bicycle 230 for connecting to a container filled with pressured air/gas carried by a wearable holder, wherein the wearable holder comprises a connector to couple the pressured air/gas to the adaptor 231; a turbine 232 attached to the bicycle 230 and connected to the adaptor 231, for converting the pressure of the air/gas to kinetic-energy for moving the bicycle 230. The adaptor 231 is attached to a fixed portion of the bicycle to connect the container to the turbine 232.

As shown in FIG. 2C, The controller 260 is located on the horizontal frame 256 and the controller 260 has a male connector 261 to connect to a female connector 262 on the bag 251. A motor 263 is connected to the controller for moving the bicycle. In one embodiment, the controller 260 has a female connector to connect to a male connector on the bag 251.

In one embodiment, as shown in FIG. 2D, an external battery 270 has two electrical contacting points 271, 272 located in a recess 273. The recess can be seated on the two corresponding contacting points 275, 276 on the horizontal frame 274 so that the external battery can be electrically connected to the controller 277. There is one bump 278 on the on the horizontal frame 274 to fit into a hole 279 in one of the wall in the recess 273 so that the battery can be attached to the bicycle firmly. A controller 277 is connected to the two electrical contacting points 271, 272.

In one embodiment, as shown in FIG. 2E, a balance/vibration sensor 280 seated on the horizontal frame 281, or a speed sensor 282 attached to the disk 283 of the front wheel, or a pressure sensor 284 attached to the inner ring of the front wheel. A controller 285 receives the signals from the balance/vibration sensor 280, speed sensor 282 or pressure sensor 284 to trigger an alarm to control the power output from the battery or to eject the connector 288 out of the adaptor 287.

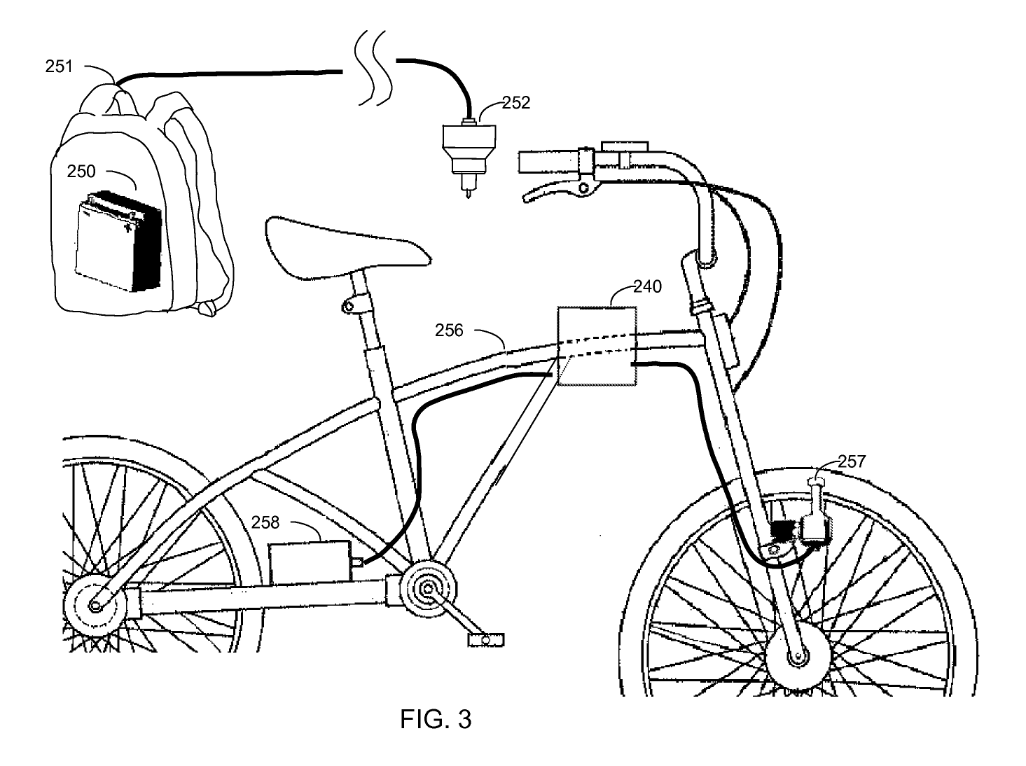

In one embodiment, as shown in FIG. 3, the apparatus for powering the bicycle comprises: an adaptor 240 on the bicycle for connecting to a first battery 250 carried by a wearable bag 251, wherein the wearable bag 251 comprises a connector 252 to couple the first battery 250 to the adaptor 240 disposed on a horizontal frame 256. In one embodiment, the controller is located at the handle or a fixed portion of the bicycle. In one embodiment, the apparatus further comprises a power generator 257 coupled to a wheel or to the motor, wherein the power generator 257 can recharge the first battery when the bicycle is running In one embodiment, a second battery 258 attached to the bicycle to provide power to the motor and the second battery 258 can be charged by the power generator 257. In one embodiment, the power generator 257 charges the second battery first which will provide the power to the motor first.

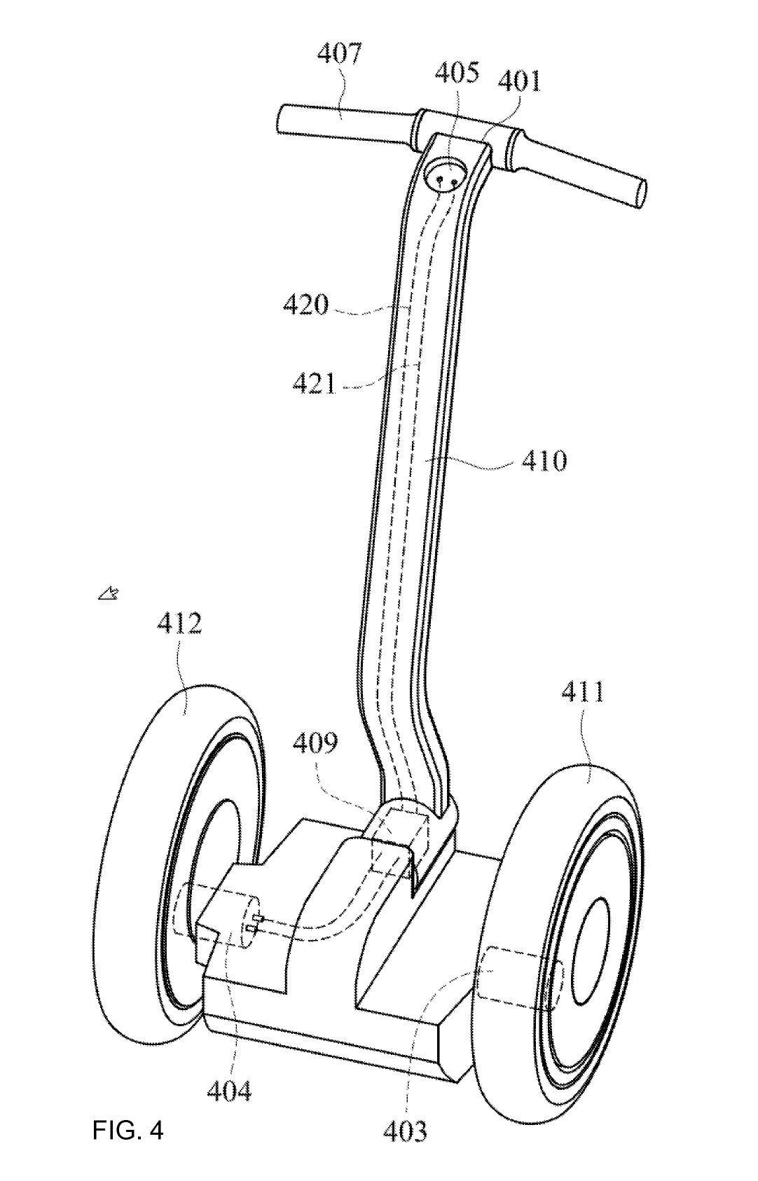

FIG. 4 illustrates a apparatus for powering a segway in accordance with one embodiment of current invention, wherein the apparatus comprises: an adaptor 405 on the segway for connecting to an external battery which can be carried by a portable holder comprising a connector 404 couple the external battery to the adaptor 405. A motor 403, 404 can be attached to the segway for moving the segway. The battery can be connected to the motor 403, 404 through wires 420; 421. The adaptor 401 is attached to a fixed portion of the segway to connect the battery to the motor 406. For example, the adaptor 405 is located at the front vertical frame 401 or the handle 407 of the segway.

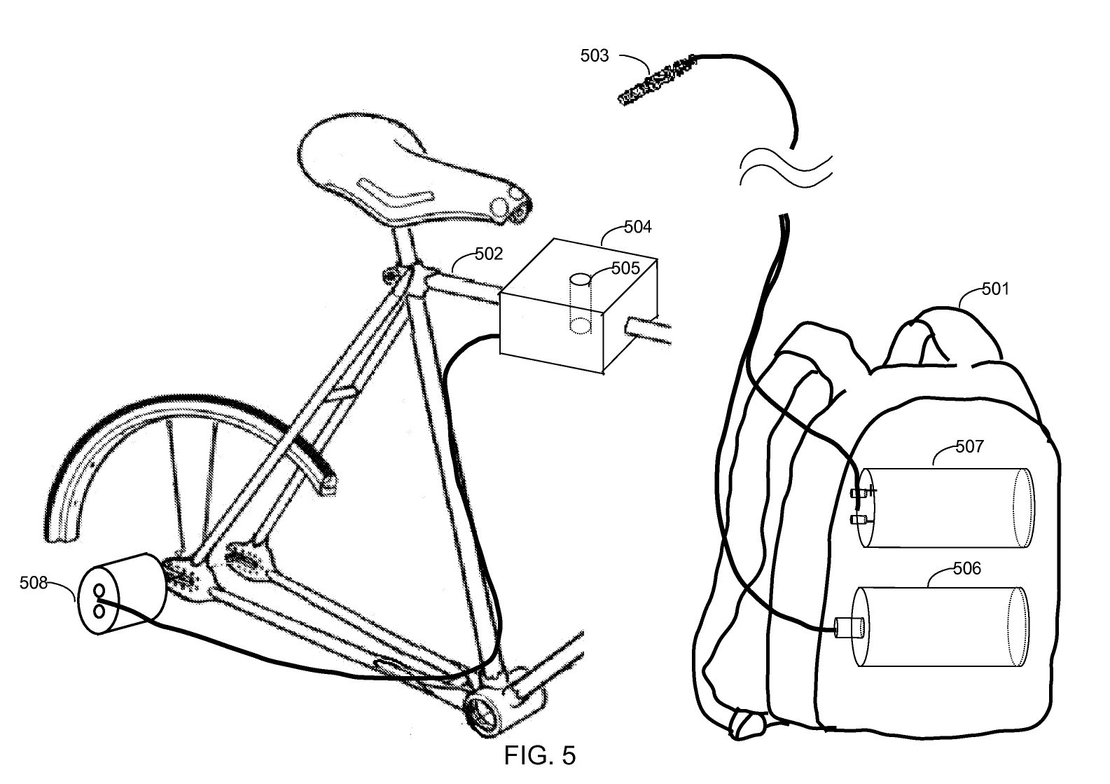

As shown in FIG. 5, The bag 501 houses a battery 507 and a container 506 filled with pressured air, which are connected to the adaptor 505 of the bicycle through the connector 503, wherein the adaptor 505 is associated with a controller 504. The adaptor and the controller are seated on the horizontal frame 502 of the bicycle. Turbine 508 is powered by the pressure from the container.

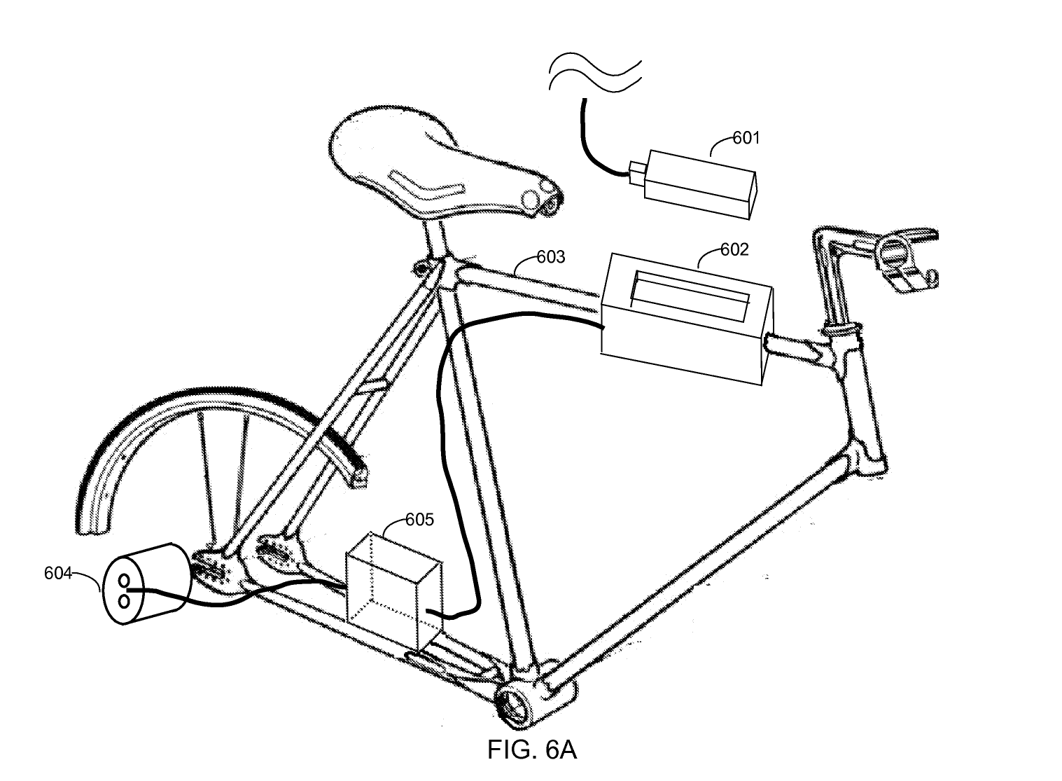

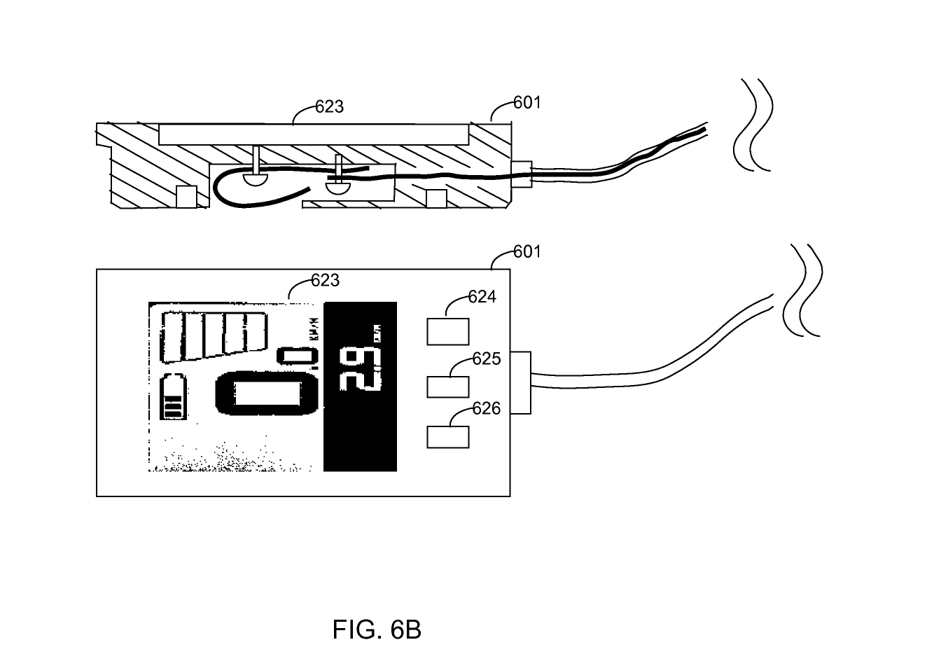

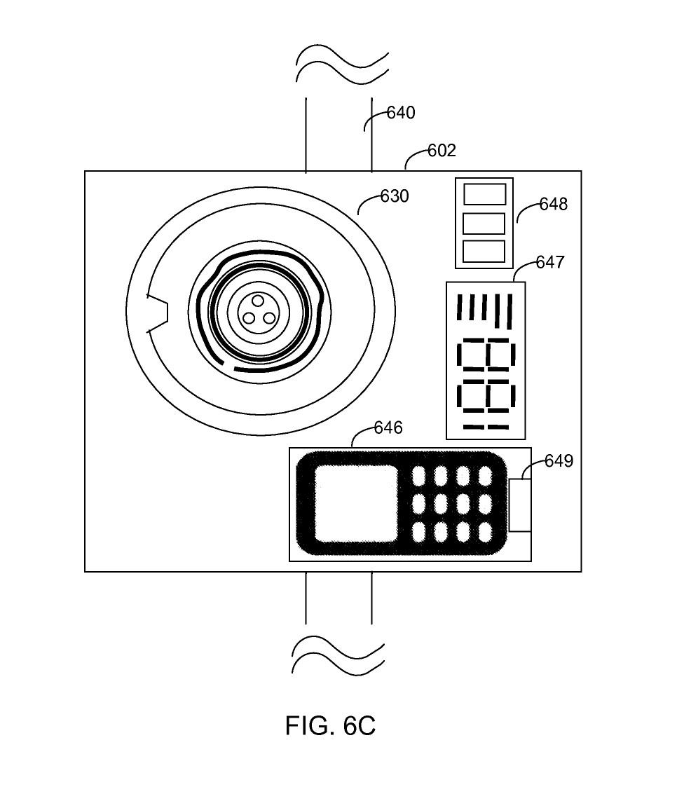

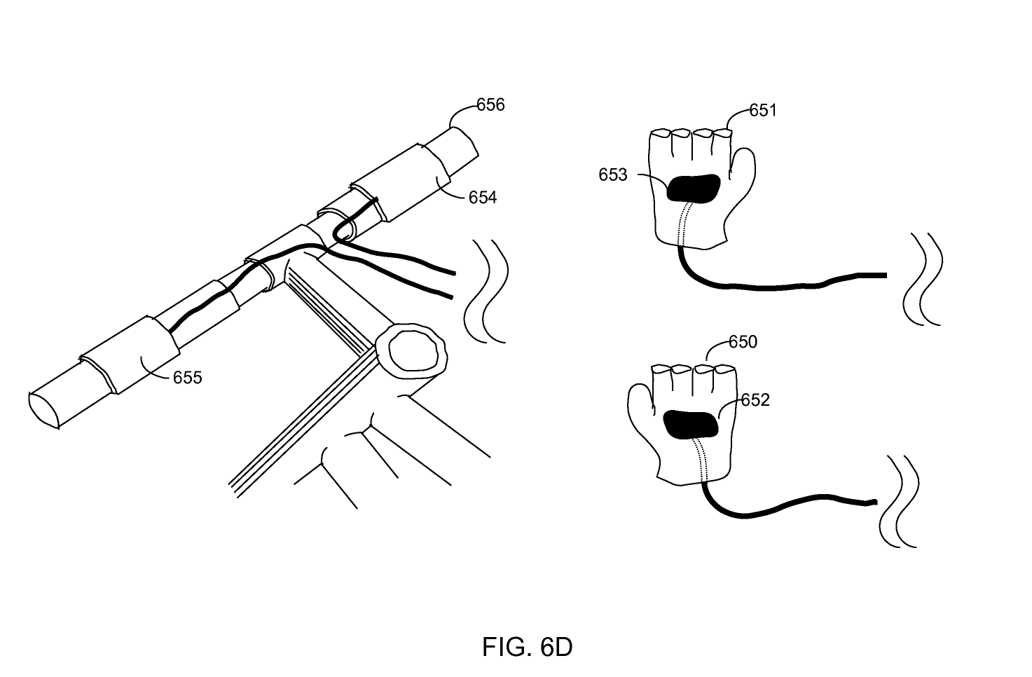

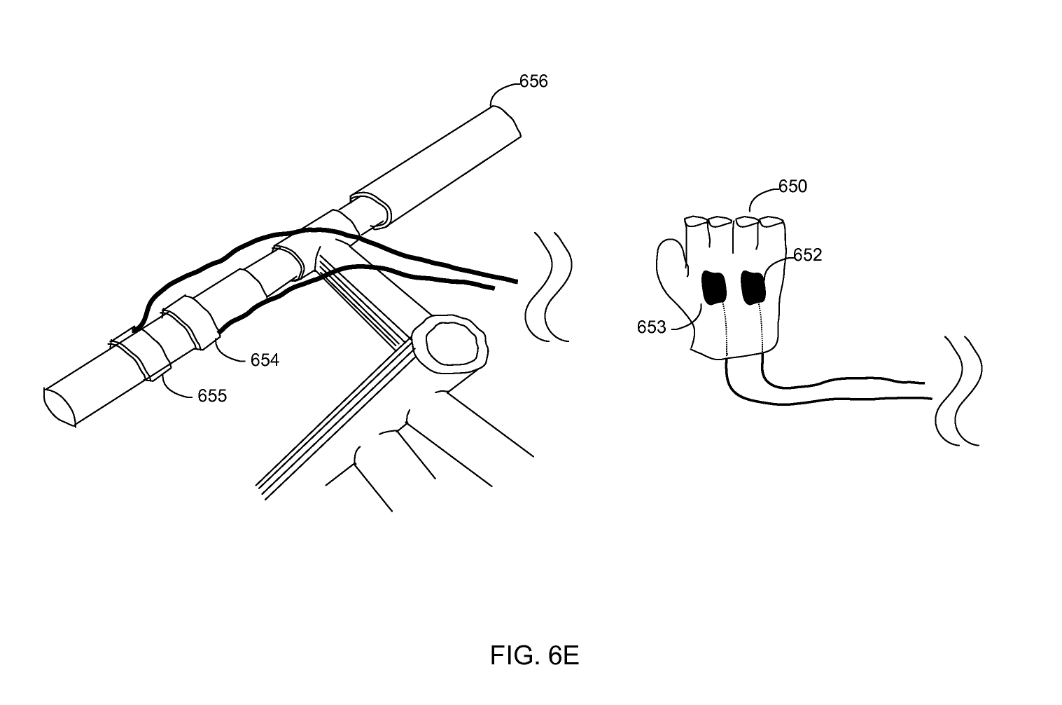

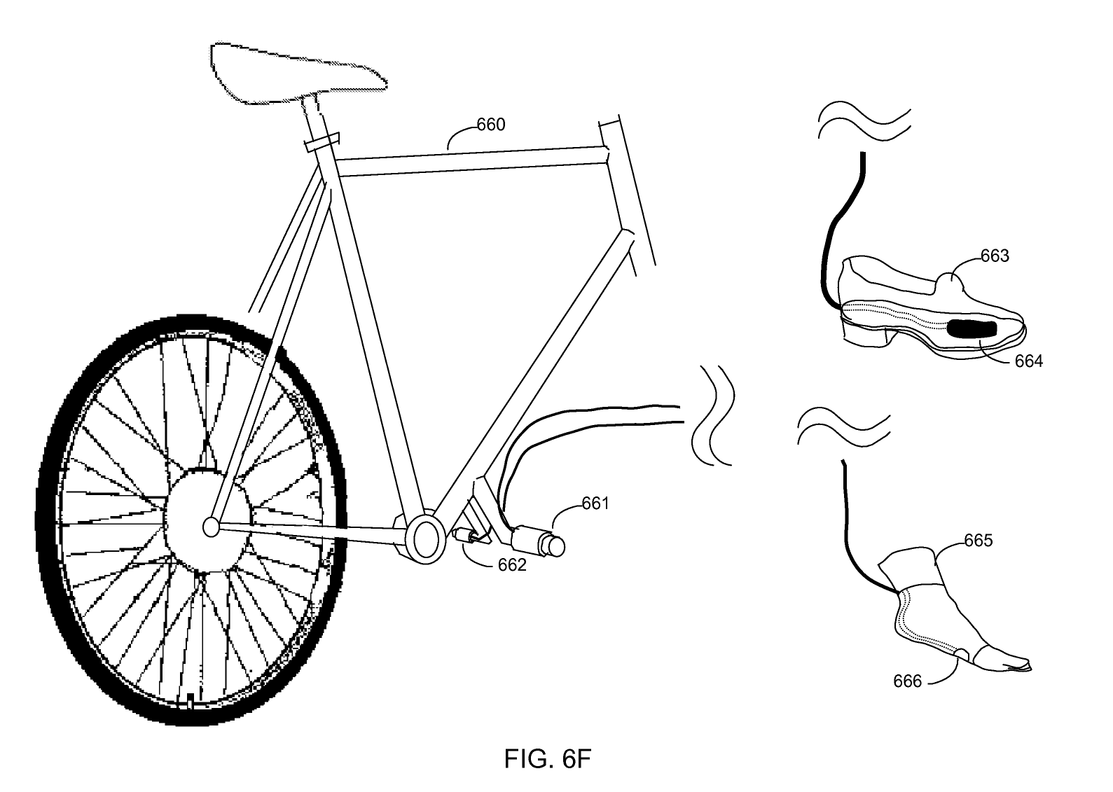

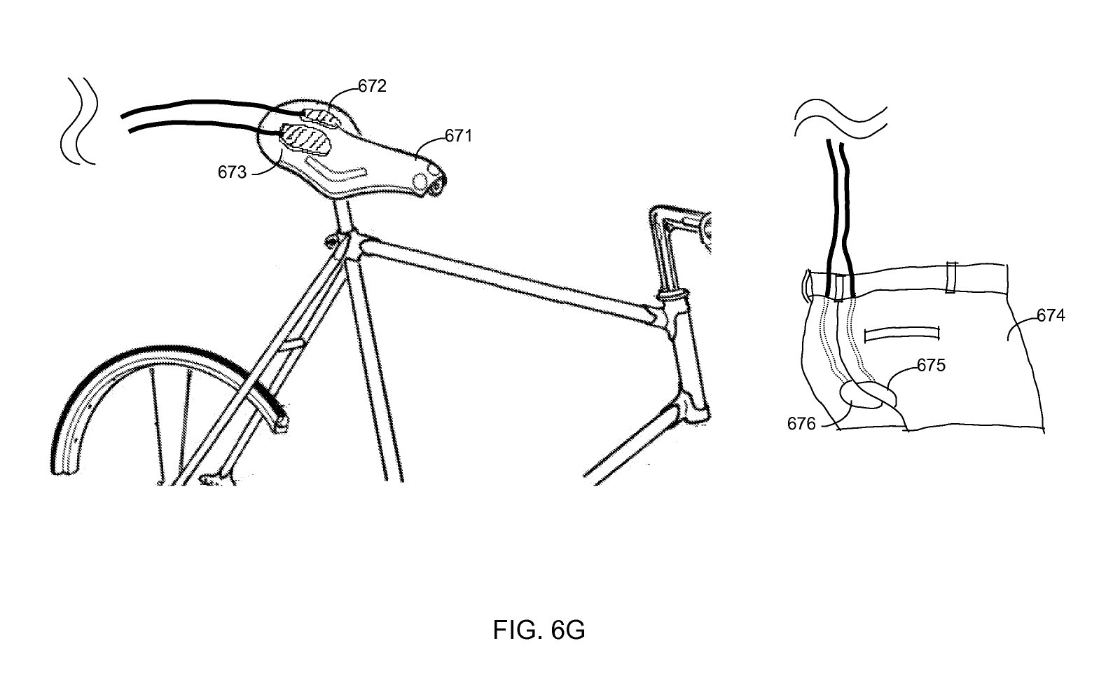

In one embodiment, as shown in FIG. 6A, a adaptor 602 is seated on the horizontal wherein the adaptor 602 has a magnetic type connector to connect a corresponding 601 from a bag. As shown in FIG. 6B, there is a display to display battery capacity, speed of the bicycle, mileage of the bicycle. As shown in FIG. 6C, the adaptor 602. which sits on the handler 640 of bicycle, has a place holder to seat a mobile phone 646 through a connector 649. There is a monitor 647 to display information. A set of buttons 648 are used to operate the monitor 647.

In one embodiment, as shown in FIG. 6D, the two electrical contacting points 654, 655 attached to the handler 656 of the bicycle. the two electrical contacting points 654, 655 can be connected to a battery through contacting points coupling to a glove on a hand, or a sock on a foot or a cloth on a body. As shown in FIG. 6E, the two electrical contacting points 654, 655 attached to one glove on one hand, or one sock on one foot. As shown in FIG. 6F, the two electrical contacting points 654, 655 attached to two socks or two shoes that will be attached to two pedals of the bicycle. As shown in FIG. 6G, the two electrical contacting points 671, 672 on the seat of the bicycle, wherein the two electrical contacting points 671, 672 will be attached to two portions 675, 676 of the cloth wrapping the buttock 674.

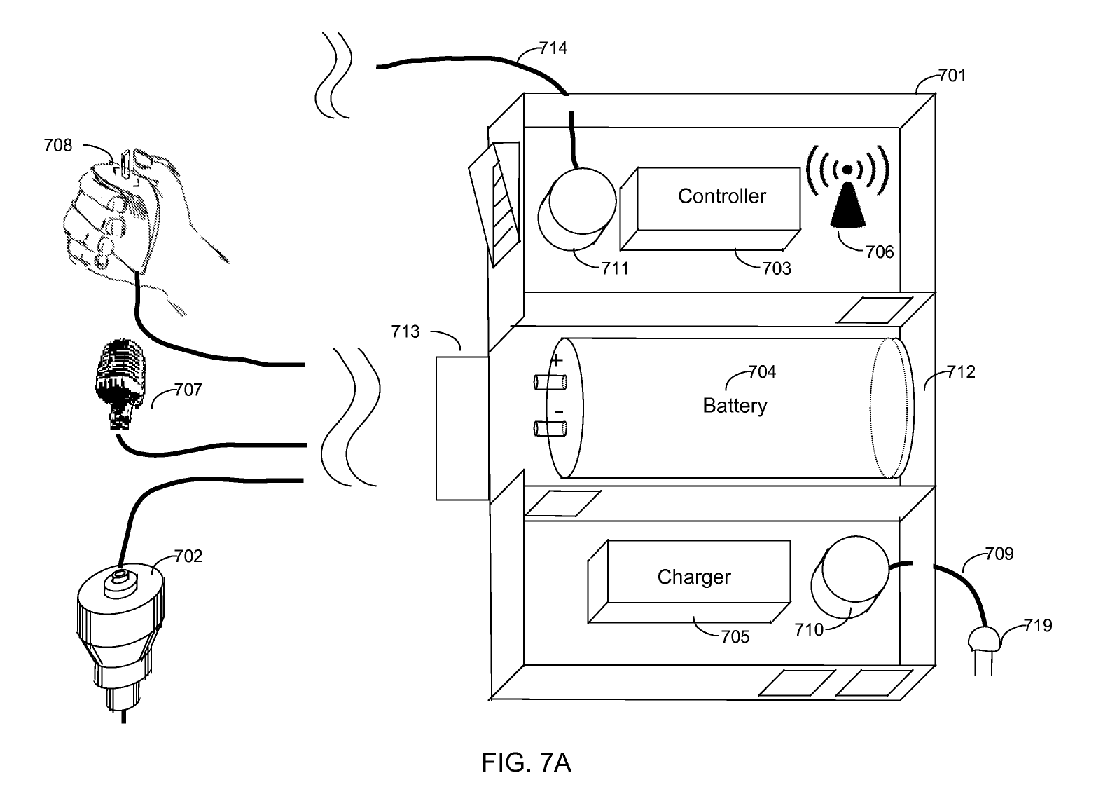

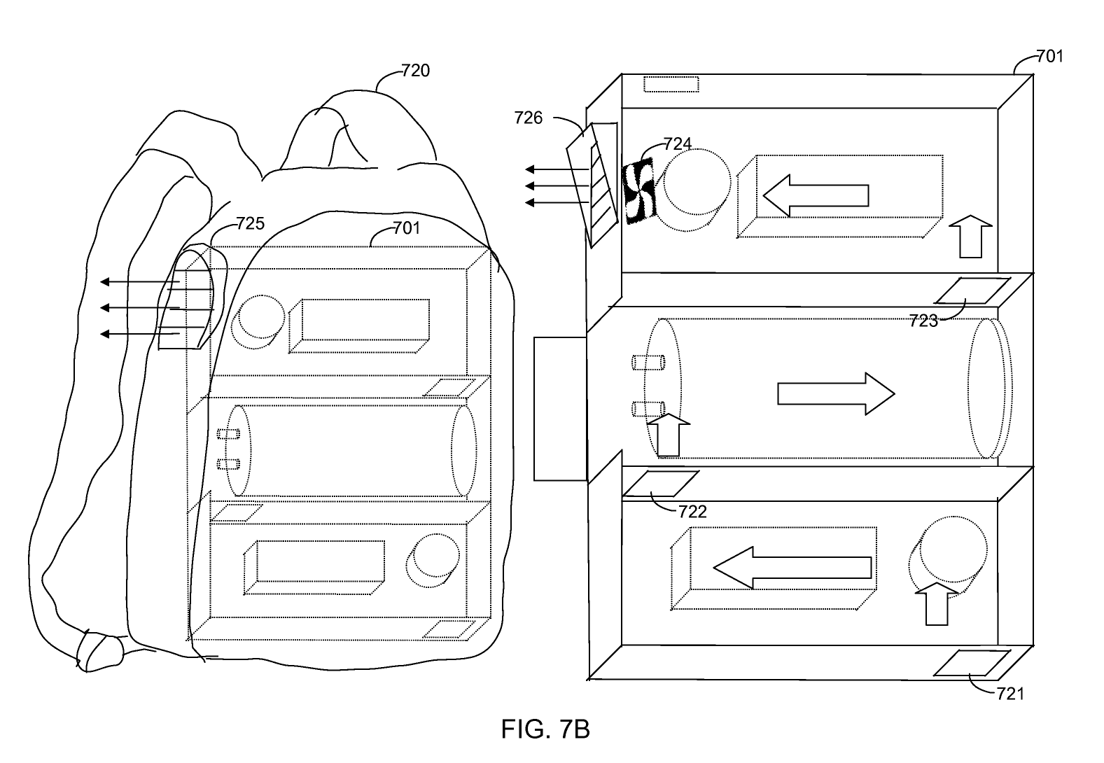

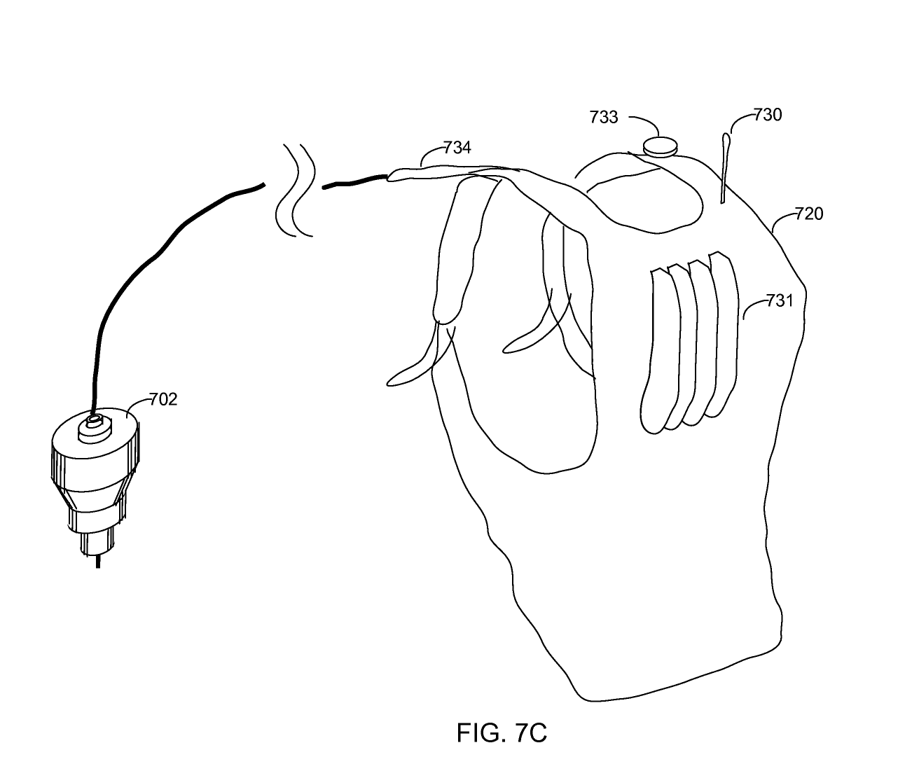

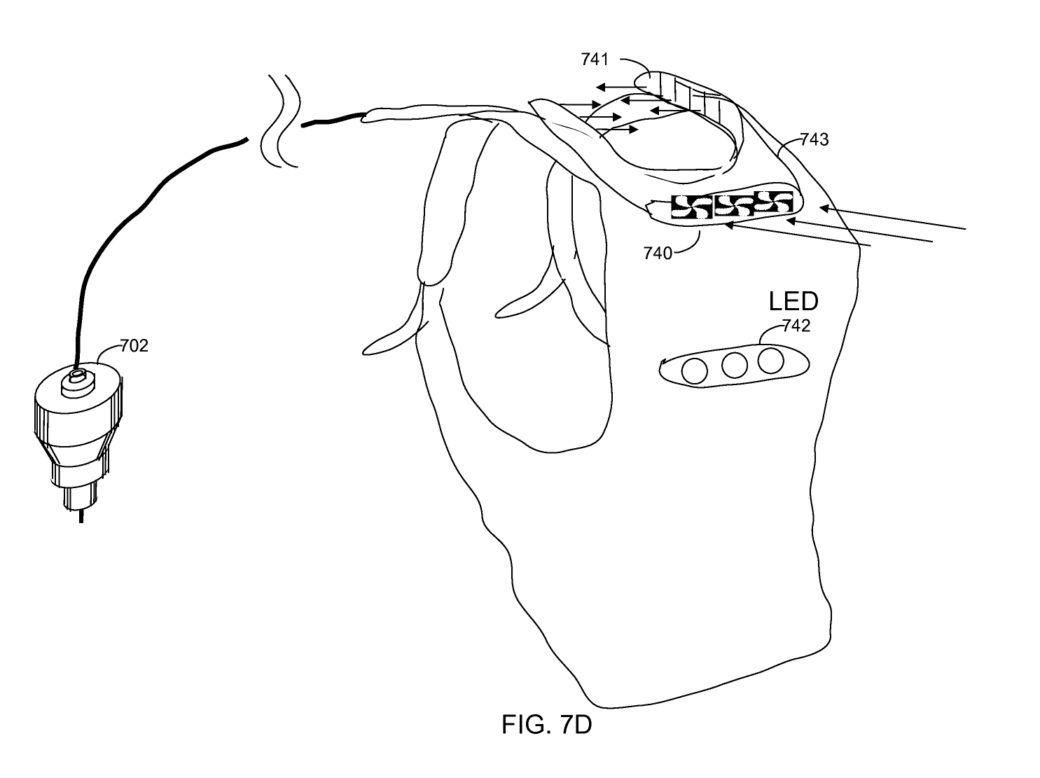

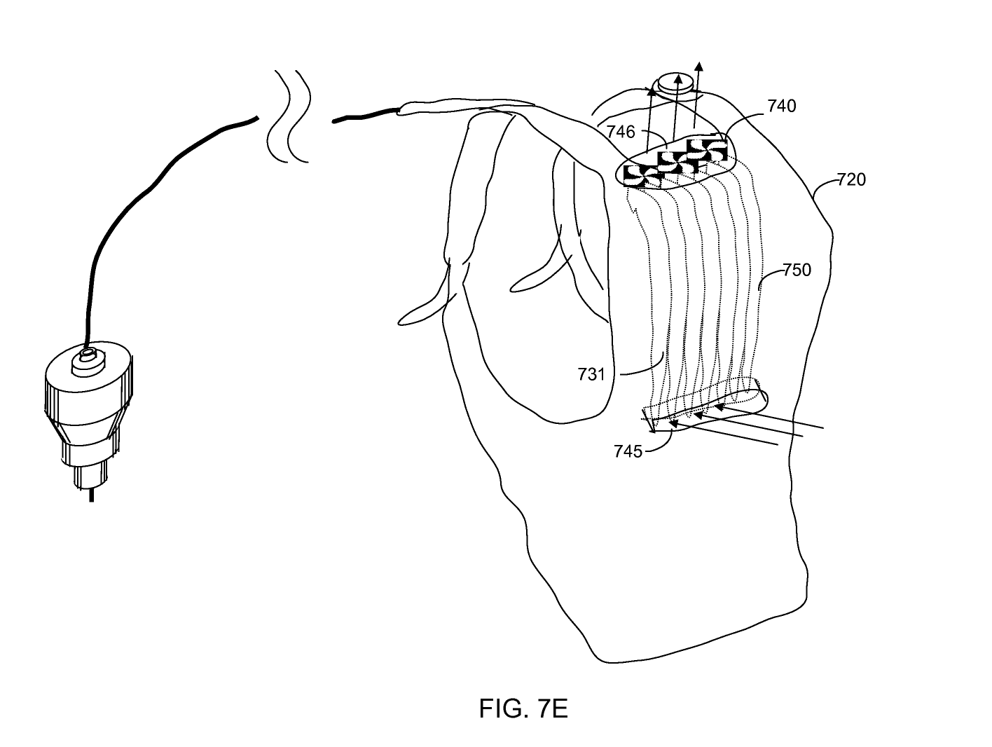

FIG. 7A illustrates an examples of a wearable bag. The wearable bag 720 has a bottom infrastructure 701, which can pack with soft material to protect itself, to hold the battery 704 and a connector 702 attached to the bag externally to connect to the adaptor of the bicycle. In addition, the wearable bag has a battery 704 charger 705 and a controller 703. The controller can be connected to a microphone 707, a joystick 708 or an antenna 706. The charger 705 has an extension code 709 and a wire house 710 for connecting the a plug 719. The connector 702 or joystick 708 can be connected to the extension code 714 and a wire house 711. There is battery house 712 with a cover 713 to house the battery 704. As shown in FIG. 7B, the wearable bag 720 has a bottom infrastructure 701 including openings 721, 722, 723, 726 through which a fan 724 can circulate the air through a opening 725 of the bag 720. As shown in FIG. 7C, the wearable bag 720 has several fins 731 on the bag to dissipate heat. There is an antenna 730 on the wearable bag 720 to communicate with a mobile phone or a controller on a bicycle. There is an emergency button 733 to shut down the power supply to the bicycle or to send SOS signal, or eject or separate the connector from the adaptor in case of an emergency. A sustainer 734 attached to the bag for holding a cord attached to the connector 702. As shown in FIG. 7D, the wearable bag 720 has a cooling system 743 which uses a fan 740 to circulate the air through an opening 741 of the cooling system to blow a cool wave to the neck of the driver riding on the bicycle. LED 742 on the bag can generate flash lights for the vehicles behind the driver of the bicycle. As shown in FIG. 7E, the wearable bag 720 has a cooling system 750 to cool down the bag internally. Opening 745 dissipate heat of the bag through a fan 740 blowing cool air from a opening 745 to fins 731 to circulate the air through an opening 746.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended

1. An apparatus for powering a movable carrier, comprising:
an adaptor on the movable carrier for connecting to an energy source carried by a portable holder, wherein the portable holder comprises a connector to couple the energy source to the adaptor;
an energy converter attached to the movable carrier and connected to the adaptor, for converting the energy source to kinetic-energy for moving the movable carrier.

2. The apparatus for powering a movable carrier according to claim 1, wherein the movable carrier is a bicycle, wherein the energy source is a battery and the energy converter is a motor, wherein the motor is attached to a wheel or a pedal of the bicycle.

3. The apparatus for powering a movable carrier according to claim 1, wherein the movable carrier is a segway, wherein the energy source is a battery and the energy converter is a motor, wherein the motor is attached to a wheel of the segway.

4. The apparatus for powering a movable carrier according to claim 1, wherein the movable carrier is a car, wherein the energy source is a high pressure air and the energy converter is a decompressor, wherein the decompressor/turbine is attached to a wheel of the car.

5. The apparatus for powering a movable carrier according to claim 2, wherein the adaptor is located at the handle, horizontal frame or a fixed portion of the bicycle.

6. The apparatus for powering a bicycle according to claim 2, wherein the adaptor is attached to the horizontal frame of the bicycle, wherein the energy source is attached to the adaptor.

7. The apparatus for powering a movable carrier according to claim 2, wherein the apparatus further comprises a power generator attached to the motor, wherein the power generator can recharge the battery when the bicycle is running.

8. The apparatus for powering a movable carrier according to claim 2, wherein the motor is located at the front or rear wheel of the bicycle.

9. The apparatus for powering a movable carrier according to claim 2, wherein the motor is located between the two pedals of the bicycle.

10. The apparatus for powering a movable carrier according to claim 2, wherein the adaptor is connected to the motor by a plurality of wires which are located inside a supporting frame of the bicycle.

11. The apparatus for powering a movable carrier according to claim 2, wherein the adaptor comprises a plug for connecting the connector of the holder.

12. The apparatus for powering a movable carrier according to claim 2, wherein the adaptor is connected to the connector of the holder attached to a hand, foot or cloth.

13. The apparatus for powering a movable carrier according to claim 11, wherein the plug is an electro-magnetic type.

14. The apparatus for powering a movable carrier according to claim 2, wherein the motor is a server motor, wherein the server motor is controlled by a controller.

15. The apparatus for powering a movable carrier according to claim 14, wherein the controller is powered by the battery.

16. The apparatus for powering a movable carrier according to claim 14, wherein the controller is located at the handle or a fixed portion of the bicycle.

17. The apparatus for powering a movable carrier according to claim 1, wherein the connector is connected to the holder through a flexible cord.

18. (canceled)

19. The apparatus for powering a movable carrier according to claim 14, wherein the controller has a balance/speed/pressure/vibration sensor to disconnect the connector of the wearable holder.

20. The apparatus for powering a movable carrier according to claim 1, wherein the portable holder is a wearable bag, wherein the wearable bag has a venting system to produce a warm/cool air through one outlet of the wearable bag.

21. The apparatus for powering a movable carrier according to claim 2, wherein the apparatus further comprises a switch or a remote control to turn on or off power from the battery to the motor.
